(19) United States
(12) Patent Application Publication
(10) Pub. No.: US 2025/0131130 A1
(43) Pub. Date: Apr. 24, 2025

(54) Social Graph Integrity Signing And Validation Mechanism

(71) Applicant: META PLATFORMS, INC., Menlo Park, CA (US)

(72) Inventor: Brandon Sloane, Lancaster, SC (US)

(21) Appl. No.: 18/145,140

(22) Filed: Dec. 22, 2022

(51) Int. Cl. G06F 21/64

(52) U.S. Cl. CPC G06F 21/64

(57) ABSTRACT

A system for establishing trust of entities associated with a system based on social graphs is provided. The system may access a first social graph including at least a first node. The first node is associated with a first set of edges and a first set of neighboring nodes associated with the first set of edges. The system may access a first signature based on the first social graph. The system may receive a request from a second node to establish a trust relationship. The system may access a second signature determined based on a second social graph in response to receiving the request. The system may determine a similarity level between the first signature and the second signature. The system may generate an indication of approval or denial of the request based on the similarity level.

### TECHNICAL FIELD

The present description generally relates to systems, apparatuses, methods, and computer-readable mediums for facilitating user authentication and/or authorization based in part on social graph integrity.

### BACKGROUND

Computer systems (e.g., social media platforms) may require access control to determine who a user is (e.g., authentication) and what the user is allowed to do in the system (e.g., authorization). One approach to authentication may include a user registering a set of credentials with a system for comparison against a set of credentials by an individual claiming to be the user. One approach to authorization may include manually assigning roles to the user, where each role has different levels of permissions to access parts of the system. Neither approach allows for authentication and/or authorization based on the attributes of a user and how the user relates to other users registered with the system.

### BRIEF SUMMARY

An aspect of the present disclosure may include a method including accessing a first social graph comprising at least a first node. The first node may be associated with a first set of edges and a first set of neighboring nodes associated with the first set of edges. The method may further include accessing a first signature based on the first social graph. The method may further include receiving, by the first node, a request from a second node to establish a trust relationship. The method may further include accessing a second signature determined based on a second social graph in response to receiving the request. The method may further include determining a similarity level between the first signature and the second signature. The method may further include generating an indication of approval or denial of the request based on the similarity level.

Another aspect of the present disclosure may include a system. The system may include a first node comprising one or more processors and at least one memory. The at least one memory may store instructions, that when executed by the one or more processors, cause the first node to access a first social graph comprising at least the first node. The first node may be associated with a first set of edges and a first set of neighboring nodes associated with the first set of edges. The memory and computer program code are also configured to, with the one or more processors, cause the first node to access a first signature based on the first social graph. The memory and computer program code are also configured to, with the one or more processors, cause the first node to receive a request from a second node to establish a trust relationship. The memory and computer program code are also configured to, with the one or more processors, cause the first node to access a second signature determined based on a second social graph in response to receiving the request. The memory and computer program code are also configured to, with the one or more processors, cause the first node to determine a similarity level between the first signature and the second signature. The memory and computer program code are also configured to, with the one or more processors, cause the first node to generate an indication of approval or denial of the request based on the similarity level.

Yet another aspect of the present disclosure may include a computer program product. The computer program product includes at least one computer-readable storage medium having computer-executable program code instructions stored therein. The computer-executable program code instructions may include program code instructions configured to access a first social graph comprising at least a first node. The first node may be associated with a first set of edges and a first set of neighboring nodes associated with the first set of edges. The computer program product may further include program code instructions configured to access a first signature based on the first social graph. The computer program product may further include program code instructions configured to receive, by the first node, a request from a second node to establish a trust relationship. The computer program product may further include program code instructions configured to access a second signature determined based on a second social graph in response to receiving the request. The computer program product may further include program code instructions configured to determine a similarity level between the first signature and the second signature. The computer program product may further include program code instructions configured to generate an indication of approval or denial of the request based on the similarity level.

### BRIEF DESCRIPTION OF THE DRAWINGS

Certain features of the subject technology are set forth in the appended claims. However, for purpose of explanation, several examples of the subject technology are set forth in the following figures.

FIG. 1 illustrates an example network environment, in accordance with one or more examples of the present disclosure.

FIG. 2 illustrates an example computing device, in accordance with one or more examples of the present disclosure.

FIG. 3 illustrates a diagram of an example process for establishing trust, in accordance with one or more examples of the present disclosure.

FIG. 4A illustrates two nodes with established trust, in accordance with one or more examples of the present disclosure.

FIG. 4B illustrates two nodes without established trust, in accordance with one or more examples of the present disclosure.

FIG. 5 illustrates a flow diagram of an exemplary process establishing trust with social graphs, in accordance with one or more examples of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more other embodiments of the subject technology. In one or more embodiments of the subject technology, structures and components are shown in block diagram form in order to avoid obscuring the concepts of the subject technology.

As defined herein, a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a centralized service or centralized platform may refer to a single authoritative source that may include a single platform and/or a set of federated platforms that act as the primary system from which others (e.g., other devices, entities, users) derive information (e.g., unique identifiers for nodes).

As referred to herein, a decentralized service or decentralized platform may refer to a plurality of authoritative sources that may operate in tandem to form a consensus agreement by mechanisms such as, for example, a voting or validation application or mechanism (e.g., peer-to-peer and/or blockchain). Then, any one of the decentralized sources may act as a system of truth for others (e.g., other devices, entities, users) to derive information (e.g., unique identifiers for nodes).

Computer systems (e.g., social media platforms) may require access control to determine who a user is (e.g., authentication) and what the user is allowed to do in the system (e.g., authorization). Access control is typically based on the identity of the user. For example, a user may register a set of credentials with a system for comparing against a set of credentials by an individual claiming to be the user. As another example, a system administrator may manually assign roles to a user in which each role has different levels of permissions to access parts of the system.

The examples of the present disclosure may base access control of the attributes of nodes utilizing or attempting to utilize the system. Because this access control is based on the attributes of the nodes, there may be less manual configuration. Attributes of a node may include the relationships of the node to other nodes in a discrete set of nodes (e.g., a social network). The nodes and their vertices (e.g., their relationships with other nodes) may form a graph (e.g., a social graph) that may be compared to the graph of another node to establish a trust relationship. A node may be associated with a system and a level of trust may determine a level of access to the system.

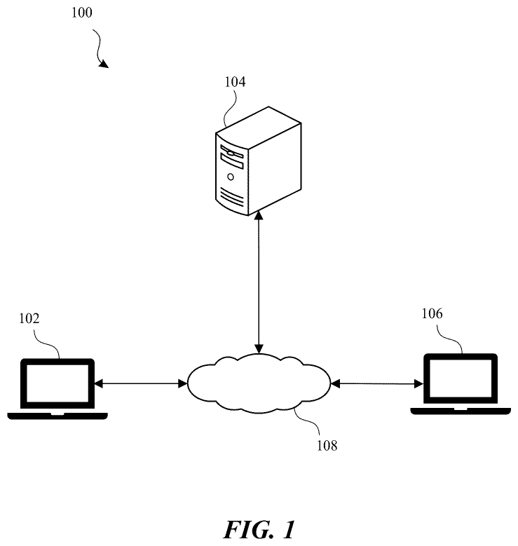

FIG. 1 illustrates a network environment 100, in accordance with one or more examples of the present disclosure. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 may include nodes 102, 106 and one or more network devices (e.g., a network device 104 (e.g., a server)). The network 108 may communicatively (directly or indirectly) couple the nodes 102, 106 and the network device 104. In one or more implementations, the network 108 may be an interconnected network of devices that may include, or may be communicatively coupled to, the Internet. For explanatory purposes, the network environment 100 is illustrated in FIG. 1 as including the nodes 102, 106 and the network device 104; however, the network environment 100 may include any number of nodes and/or any number of network devices communicatively coupled to each other directly or via the network 108. Aspects of the subject technology may allow for the comparison of relationship graphs between any of nodes 102, 106 and the network device 104.

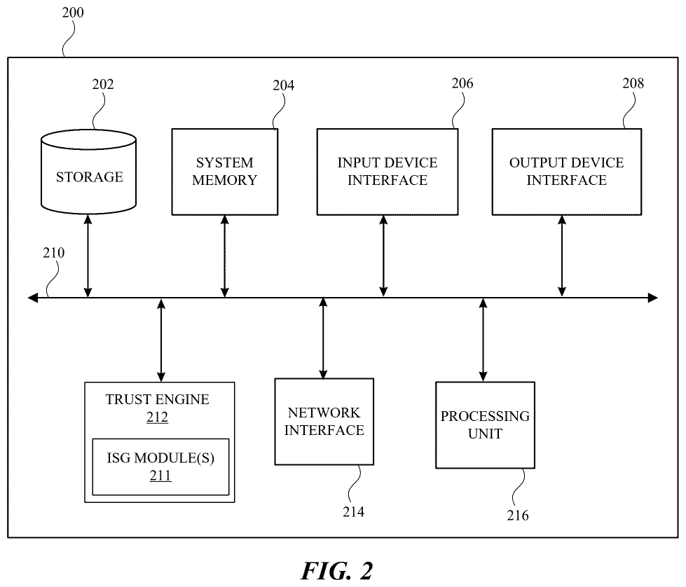

The nodes 102, 106 may be a desktop computer, a portable computing device such as a laptop computer, a smartphone, a tablet device, or any other appropriate device that includes, for example, one or more wireless interfaces, such as wireless local area network (WLAN) radios, cellular radios, Bluetooth radios, Zigbee radios, near field communication (NFC) radios, and/or other wireless radios. The nodes 102, 106 may be, and/or may include all or part of, the electronic system discussed below with respect to FIG. 2. In one or more implementations, the nodes 102, 106 may include a list of other nodes with which the nodes 102, 106 have a relationship as well as attributes of the relationship.

In one or more implementations, one or more network devices (e.g., the network device 104) may facilitate a trust relationship between nodes (e.g., the nodes 102, 106). One or more network devices may include a mechanism for establishing unique node identifiers. For example, nodes in a particular group may each have unique identifiers and nodes in multiple groups may have a unique identifier for each group of which they are a part. One or more network devices may be a host for a group that may include multiple nodes. For example, a network device may host a social media platform that may include a group of nodes, some of which may have a relationship with other nodes on the social media platform. One or more network devices may store information relating to nodes and nodes associated therewith. One or more network devices may include a trust engine for establishing trust thresholds between hashing similarity and may use the thresholds to confirm authorization of nodes for particular activities. One or more network devices may cache social graphs of nodes such that a node may access its associated cache rather than rebuild it or access the cache of another node in an instance in which a trust relationship is established.

FIG. 2 illustrates an example computing device 200, in accordance with one or more examples of the present disclosure. The computing device 200 may be, and/or may be a part of, nodes 102, 106 and/or network device 104. The computing device 200 may include various types of computer-readable media and interfaces for various other types of computer-readable media. The computing device 200 includes a bus 210, a system memory 204, a storage device 202, an input device interface 206, an output device interface 208, a trust engine 212, a network interface 214, and a processing unit 216, or subsets and variations thereof. Not all depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

The bus 210 collectively represents all system, peripheral, and chipset buses that communicatively connect the numerous internal devices of the computing device 200. In one or more embodiments, the bus 210 communicatively connects the processing unit 216 with the other components of the computing device 200. From various memory units, the processing unit 216 retrieves instructions to execute and data to process in order to execute the operations of the subject disclosure. The processing unit 216 may be a controller and/or a single- or multi-core processor or processors in various embodiments.

The storage device 202 may be a read-and-write memory device. The storage device 202 may be a non-volatile memory unit that stores instructions and data (e.g., static and dynamic instructions and data) even when the computing device 200 is off. In one or more embodiments, a mass-storage device (such as a magnetic or optical disk and its corresponding disk drive) may be used as the storage device 202. In one or more embodiments, a removable storage device (such as a floppy disk, flash drive, and its corresponding disk drive) may be used as the storage device 202.

Like the storage device 202, the system memory 204 may be a read-and-write memory device. However, unlike the storage device 202, the system memory 204 may be a volatile read-and-write memory, such as random-access memory. The system memory 204 may store any of the instructions and data that one or more processing unit 216 may need at runtime to perform operations. In one or more embodiments, the processes of the subject disclosure are stored in the system memory 204 and/or the storage device 202. From these various memory units, the one or more processing unit 216 retrieves instructions to execute and data to process in order to execute the processes of one or more embodiments, discussed below.

Embodiments within the scope of the present disclosure may be partially or entirely realized using a tangible computer-readable storage medium (or multiple tangible computer-readable storage media of one or more types) encoding one or more instructions. The tangible computer-readable storage medium also may be non-transitory in nature.

The computer-readable storage medium may be any storage medium that may be read, written, or otherwise accessed by a general purpose or special purpose computing device, including any processing electronics and/or processing circuitry capable of executing instructions. For example, without limitation, the computer-readable medium may include any volatile semiconductor memory (e.g., the system memory 204), such as RAM, DRAM, SRAM, T-RAM, Z-RAM, and TTRAM. The computer-readable medium also may include any non-volatile semiconductor memory (e.g., the storage device 202), such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium may include any non-semiconductor memory, such as optical disk storage, magnetic disk storage, magnetic tape, other magnetic storage devices, or any other medium capable of storing one or more instructions. In one or more embodiments, the tangible computer-readable storage medium may be directly coupled to a computing device, while in other embodiments, the tangible computer-readable storage medium may be indirectly coupled to a computing device, e.g., via one or more wired connections, one or more wireless connections, or any combination thereof.

Instructions may be directly executable or may be used to develop executable instructions. For example, instructions may be realized as executable or non-executable machine code or as instructions in a high-level language that may be compiled to produce executable or non-executable machine code. Further, instructions also may be realized as or may include data. Computer-executable instructions also may be organized in any format, including routines, subroutines, programs, data structures, objects, modules, applications, applets, functions, etc. As recognized by those of skill in the art, details including, but not limited to, the number, structure, sequence, and organization of instructions may vary significantly without varying the underlying logic, function, processing, and output.

While the above discussion primarily refers to microprocessors or multi-core processors that execute software, one or more embodiments are performed by one or more integrated circuits, such as ASICs or FPGAs. In one or more embodiments, such integrated circuits execute instructions that are stored on the circuit itself.

The bus 210 also connects to the input device interface 206 and output device interface 208. The input device interface 206 enables the system to receive inputs. For example, the input device interface 206 allows a user to communicate information and select commands on the computing device 200. The input device interface 206 may be used with input devices such as keyboards, mice, dials, switches, sliders, and other interfaces (physical or virtual) for a user to supply information to the computing device 200. The output device interface 208 may be used with output devices such as displays, speakers, and other interfaces (physical or virtual) for the computing device 200 to provide information. One or more embodiments may include devices that function as both input and output devices, such as a touchscreen.

The bus 210 also couples the computing device 200 to one or more networks and/or to one or more network nodes through the network interface 214. The network interface 214 may include one or more interfaces that allow the computing device 200 to be a part of a network of computers (e.g., a local area network (LAN), a wide area network (WAN), or a network of networks (the Internet)). For example, the network interface 214 may include a network interface card (NIC).

The computing device 200 may also include a trust engine 212. The trust engine 212 may be hardware and/or software configured to determine whether a trust relationship may be established between two or more parties (e.g., nodes). The trust engine 212 may include one or more integrity signature generation modules 211 (also referred herein as ISG module(s) 211), which may analyze connections (e.g., first-order connections) associated with the computing device 200 and may generate a token(s) (e.g., a hash(es)) based on the unique identifiers of the connections. The integrity signature generation modules 211 may employ/utilize locality sensitive hashing applications and/or mechanisms to generate the token(s), which may ensure that nodes having similar first-order connections may have similar token values. In a decentralized system (e.g., implemented by an electronic device), the trust engine 212 may receive a token from another node to establish a level of trust based on the degree of similarity between the values of the tokens. In a centralized system (e.g., implemented by a network device), the trust engine 212 may receive tokens from multiple parties (e.g., nodes) and establish a level of trust based on the degree of similarity between the values of the tokens and output to the parties to the level of trust the parties have between each other.

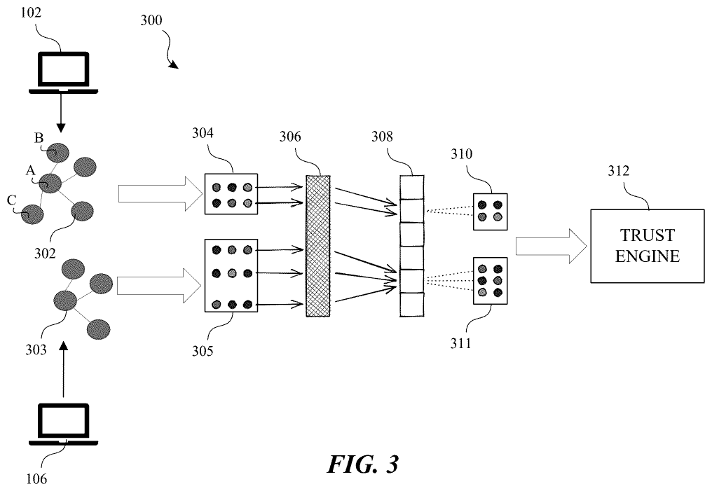

FIG. 3 illustrates a diagram of an example process 300 for establishing trust, in accordance with one or more examples of the present disclosure. In FIG. 3, two nodes (e.g., nodes 102, 106) may access (e.g., download, query, generate, derive) their respective social graphs 302, 303. The social graphs 302, 303 may be generated by the nodes 102, 106 themselves or by a centralized node (e.g., a network device 104). A social graph may include relationships that a central node (e.g., nodes 102, 106) has with other nodes, in which the relationships may be represented by edges in the graph. For example, the edges may represent the presence of a connection or relationship between at least two nodes. The edges may be the endpoints associated with connecting lines connecting the nodes associated with the relationship(s). The relationships may be first-order (e.g., direct) relationships with the central node and may have an associated value. The value of a relationship may be a function of variables such as the type of relationship (e.g., a friend or a follower, in a social network context), an age of the relationship, interactions with the relationship (e.g., posts, messages or tags, in a social media context) and/or other characteristics relating to a relationship between nodes. The nodes included in a social graph may be nodes belonging to a common group. A common group may be a group in which nodes belonging to the group may be assigned a unique identifier. A node may be in multiple common groups with the same or different nodes and may have multiple unique identifiers, one for each common group to which the node belongs. For example, a common group may be a social network, in which nodes in the social network may be represented by user profiles, and edges may be associated with friends of user profiles.

A common group may be associated with a centralized service (e.g., network device 104) that assigns unique identifiers to nodes based on a predetermined mechanism or application. In an instance in which a node is registered with multiple social media platforms, each social media platform may assign the node a unique identifier via the same or different mechanism or application. For example, the mechanism/application may include assigning unique identifiers as sequential values as users register with a social media platform(s), generating unique identifiers based on a random value assigned to users as they register with a social media platform(s). A common group may also or instead be associated with a decentralized service that assigns unique identifiers to nodes. For example, a social media platform may utilize a blockchain to assign unique identifiers to nodes, in which a block represents a node and relationships between blocks represent relationships between the nodes.

Nodes and/or edges of the social graphs 302, 303 may each be mapped to one or more numerical constructs (e.g., hexadecimal values, decimal values), such as values 304, 305, based on a value generation mechanism implemented by the network device 104. For example, a value may be the unique identifier of a node (e.g., node A) in the social graph 302 added with the values of the node's edges (e.g., node B, node C). The value generation mechanism may be set by a centralized service (e.g., from the common group) or agreed upon between nodes seeking to share encrypted communications (e.g., via handshake process). Accordingly, the values 304, 305 may be derived/determined from the social graphs 302, 303 respectively by the same process, though not necessarily by the same entity (e.g., each node may derive its own key values in some examples).

The values 304, 305 may be input into a hashing module 306, which may be set by the centralized system (e.g., network device 104) or agreed upon by the nodes 102, 106. Through the hashing algorithm 306, social graphs with similar relationships may, but need not, hash similar values, which provides a measure of the degree to which different social graphs overlap at a point in time. The hashing module 306 may implement any mechanism for generating hashes such as, for example, MinHash, SimHash, and/or the like. The output of the hashing module 306 may be grouped by similarity into a set of hash buckets 308 (also referred to herein as hash groups 308). The hash buckets 308 may be a collection of hashes, where the number of buckets may be smaller than the candidate pool of possible input items. For purposes of illustration and not of limitation, hundreds of key values may be derived/determined from a social graph but there may be only 20 hash buckets. In one or more examples, the hashing module 306 and the hash buckets 308 may be based on a locality sensitive hashing (LSH) mechanism/application, which may place hashes of similar input values into the same or similar buckets/groups.

In response to using an LSH mechanism/application, similar social graphs may likely hash to the same bucket of the hash buckets 308. This bucket may then represent a single key 310, which may then be used as inputs to a trust engine 312 (e.g., trust engine 212). The trust engine 312 may be a centralized or decentralized service that establishes trust thresholds based on hashing similarity and may use the thresholds to confirm authorization for node 102 and/or node 106 to perform one or more desired activities. In one or more examples, the number of buckets of the hash buckets 308 may be increased or decreased to increase or decrease, respectively, a likelihood that two social graphs may hash to the same bucket, thereby establishing a threshold level of similarity. In one or more examples, the LSH mechanism/application may provide one or more intermediary activities to translate the value that the bucket represents into a key. Translating the value that the bucket represents into a key may include leveraging another key generation cryptographic mechanism or application. In some other examples, the network device 104 may provide the one or more intermediary activities to translate the value that the bucket represents into a key.

For example, consider an instance in which nodes 102, 106 have many overlapping friends (e.g., mutual friends) on a social network. The nodes 102, 106 respective social graphs 302, 303 may hash to the same bucket of the hash buckets 308. In this regard, in an instance in which node 102 attempts to invite node 106 to join a group, the trust engine 312 may analyze their mutual friends at that point in time and determine whether node 106 joining the group is a trusted activity with a high degree of confidence. If it is a trusted activity, as determined by the trust engine 312, the trust engine 312 may allow the invitation to be received by the node 106. Also consider an instance in which a third node may have few overlapping friends with the node 106. If the third node attempts to invite node 106 to join the group, the trust engine 312 may determine a lack of social graph similarity (e.g., based on the third node and node 106's respective social graphs hashing to different buckets) and may designate the action as a potentially non-trusted activity. In response to the non-trusted activity, determined by the trust engine, the trust engine 212 may take an action(s) such as for example prohibiting the invitation (e.g., temporarily or permanently).

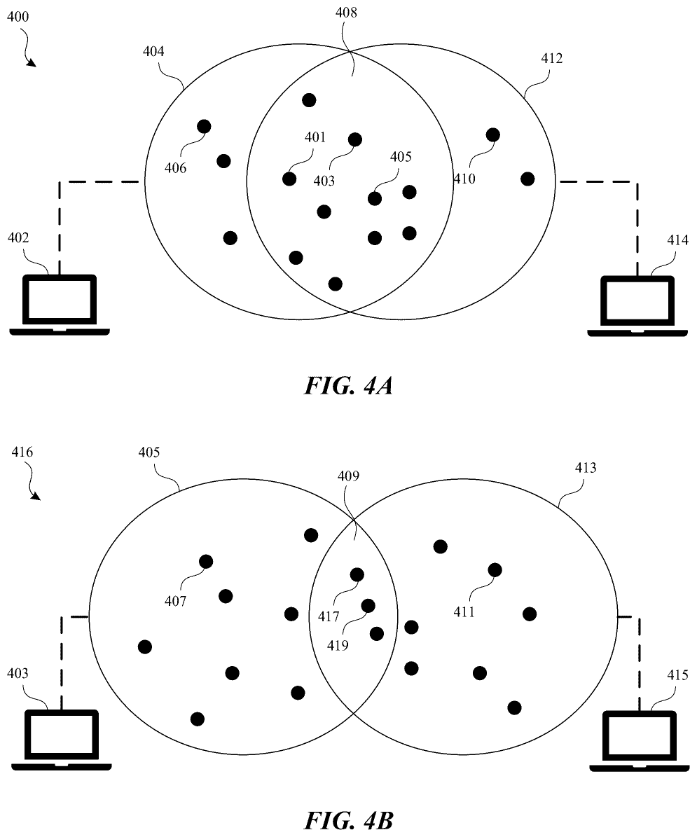

FIG. 4A illustrates a scenario 400 in which two nodes 402, 414 have established trust, in accordance with one or more examples of the present disclosure. Not all depicted components may be used in all examples, however, and one or more examples may include additional or different components than those shown in the figure. Variations in the arrangement and type of the components may be made without departing from the spirit or scope of the claims as set forth herein. Additional components, different components, or fewer components may be provided.

In the example of FIG. 4A, a node 402 may want to establish a trust relationship with a node 414, in which the node 414 may provide a service requiring one or more degrees of authorization for access. One approach for establishing authorization of the node 402 may be to manually assign a role to the node 402 where the role has predefined rules for authorization. For example, one role may be administrator, which grants a node full authorization to read/write data and use a service, and another role may be user, which grants a node only the authorization to read select items of data and use the service.

The examples of the present disclosure may utilize node identities of connections (e.g., first-order connections) to generate social graph signatures and utilized similarity comparisons to determine degrees of trustworthiness between nodes for activity authorization. Take, for example, nodes 402, 414. The node 402 may have a set of first-degree connections 404 including nodes 406, 408, and the second node 414 may have a set of first-degree connections 404 including nodes 408, 410. The nodes in the set of connections 404, 412 may all be part of a common group, such as belonging to a social media platform, a group within a social media platform, a geographic location, a type of device, and/or any other common attribute between the nodes. Each node in the set of connections 404, 412 may have an identifier that is unique to each respective node in a common group. Each node in the set of connections 404, 412 may also have an assigned value. The assigned value may be a function of a node's unique identifier, connection with other nodes in the set of connections 404, 412, attributes of the connections with other nodes in the set of connections 404, 412, and/or any other attributes of a node and/or its connections. The assigned value may also be hashed into a key value with any suitable hashing mechanism for similarity comparison, such as for example SimHash or MinHash. The values (e.g., key values) of the nodes associated with the set of connections 404, 412 may be grouped into a set of buckets (e.g., a set of groups)) in which each bucket may represent one or more values that may be found in a key. For purposes of illustration and not limitation, in an instance in which the hashing mechanism generates 128-bit hash values, a bucket may include the first eight bits. Because the nodes 402, 414 may have many shared nodes 408 (e.g., nodes 401, 403, 405, etc.), the nodes 402, 414 may each generate x of the same (or similar) hash values, where x is the number of shared nodes 408. Because the shared nodes 408 may result in the same (or similar) hash values, they may be grouped into the same hash bucket. The hash bucket may include a single value that represents the bucket. In one or more examples, the common group for establishing

authentication/trustworthiness of nodes may not need to be the same group and the group for which the node 402 is seeking authorization. For example, the node 402 may be seeking authorization for a group on a social media platform to which the node 414 belongs, but the common group that is referenced to determine social graphs utilized for authentication/trustworthiness of nodes, may be a geographic location associated with common nodes rather than connections on the social media platform.

FIG. 4B illustrates a scenario 416 in which two nodes 403, 415 have not established trust, in accordance with one or more examples of the present disclosure. Not all depicted components may be used in all examples, however, and one or more examples may include additional or different components than those shown in the figure. Variations in the arrangement and type of the components may be made without departing from the spirit or scope of the claims as set forth herein. Additional components, different components, or fewer components may be provided.

In the scenario 416, the node 403 may have a set of first-degree connections 405 including nodes 407, 409, the second node 415 may have a set of first-degree connections 413 including nodes 409, 411. The nodes in the set of connections 405, 413 may all be part of a common group, and may each have an identifier that is unique to each of the respective nodes in the common group. Each of the nodes in the set of connections 405, 413 may also have an assigned value that may be converted into a key value by a hashing mechanism. The values (e.g., key values) of the nodes in the set of connections 405, 413 may be grouped into a set of buckets (e.g., as set of groups), in which the buckets may represent one or more values that may be found in a key, where the key may include any number of attributes (e.g., metadata tags) of the nodes including age, degrees (e.g., size), activity, history, and/or the like. Because the nodes 403, 415 have shared nodes 409 (e.g., node 417, node 419, etc.), the nodes 403, 415 may each generate x of the same (or similar) hash values, where x is the number of shared nodes 409. Because the shared nodes 409 may result in the same (or similar) hash values, they may be grouped into the same hash bucket. The number of values in a hash bucket may indicate a degree of common connections between the nodes 403, 415 without revealing the identity of particular connections. The degree of trust between the nodes 403, 415 may be commensurate to the number of hash values in one or more buckets. A trust relationship may not be established between the nodes 403, 415 in an instance in which the number of hash values in one or more buckets is below a predetermined threshold (e.g., predetermined threshold number). For example, if each of the shared nodes 409 is hashed into values that are grouped into the same bucket and the predetermined threshold such as a predetermined threshold value for authenticating the node 403 (and/or the node 415) is five, the node 403 (and/or 415) may not be authenticated because a corresponding hash bucket associated with the hash values may include four values (e.g., one for each of the shared nodes 409 associated with each of the nodes 403, 415).

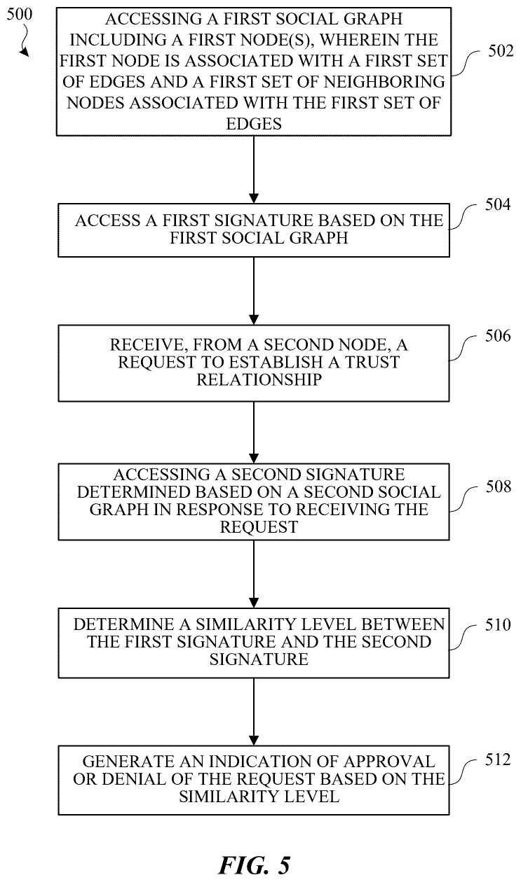

FIG. 5 illustrates a flow diagram of a process 500 for establishing trust with social graphs, in accordance with one or more examples of the present disclosure. For explanatory purposes, the process 500 is primarily described herein with reference to FIGS. 1, 2, 3, 4A and 4B. However, the process 500 is not limited to the items shown in FIGS. 1, 2, 3, 4A and 4B, and one or more blocks (or operations) of the process 500 may be performed by one or more other components of other suitable devices. Further, for explanatory purposes, the blocks of the process 500 are described herein as occurring in serial or linearly. However, multiple blocks of the process 500 may occur in parallel. In addition, the blocks of the process 500 need not be performed in the order shown and/or one or more blocks of the process 500 need not be performed and/or may be replaced by other operations.

In the process 500, at block 502, a first node (e.g., a node 102) may access a first social graph (e.g., the social graph 302) comprising at least the first node. The first node may be associated with a first set of edges and a first set of neighboring nodes associated with the first set of nodes. In some examples, the first set of edges and the first set of neighboring nodes may also be included in the first social graph. Accessing may include retrieving from memory, receiving from another party/device, downloading from local/remote storage, generating, or any other form of obtaining the social graph (e.g., the first social graph). For example, the first node may request and receive its social graph from network device 104 and/or a third party (e.g., another server associated with network environment 100). As another example, the first node may generate its social graph (e.g., social graph 302) based on its known connections with other nodes.

A social graph may include any set of neighboring nodes, which may include zero or more nodes, with which the first node has any relationship. For example, the nodes included in a social graph may be nodes that have a direct relationship with the first node (e.g., first-order connections 404). In one or more other examples, the nodes included in a social graph may also be nodes that have an indirect relationship with the first node (e.g., second order connections, third order connections, etc.). In one or more other examples, the nodes may have different types of relationships. For example, a social media platform may distinguish between friendship connections versus casual messaging connections or other strong versus weak connections.

The nodes related (directly or indirectly) to the first node may have a common characteristic(s) associated with the first node. For example, the nodes may be friends on a social network, members of a group, nodes in a geographic location, nodes of the same type of device, or any other common characteristics associated with the nodes. Nodes related to the first node and the first node may have a unique identifier assigned based on the common characteristic(s), which may be assigned by one of the nodes or a third party (e.g., a server).

The nodes may be connected with edges (e.g., edge node A, edge node B of FIG. 3), forming a graph data structure. The edges may have a value representing one or more characteristics of the relationship(s) between the nodes connected to the edges. An edge that connects a pair of nodes may have a value based on the duration of a connection (e.g., a connection with other nodes), a type of connection, weights associated with a connection, or any other characteristics of the relationship(s) between the pair of nodes.

At block 504, the first node may access a first signature (e.g., the first node's signature) based on the first node's social graph (social graph 302). A signature may be represented by a capture of a network representation of connections and history at a point in time. The signature representation may then be translated into a numerical value that may then pass through a signing mechanism, such as a hashing function, to provide an integrity checking mechanism for future trust verification. Accessing may include retrieving from memory, receiving from another party/device, downloading from local/remote storage, generating, or any other form of obtaining the first node's signature. For example, the first node may request and receive its signature from a network device (e.g., network device 104) and/or a third party (e.g., a server), which may generate and/or store the signature. As another example, the first node may generate its signature based on its known connections with other nodes identified in an associated social graph. In one or more examples, the signature may be stored at a network device, such as network device 104, for subsequent access.

The signature of the first node (e.g., node 102) may be derived from a set of attributes associated with the first node's social graph. Such attributes may include attributes of the edges and/or nodes (e.g., the first node and its neighboring nodes) of the social graph as well as interactions between the nodes of the social graph. Attributes of the edges may include values assigned to the edges and/or any characteristic derived from the values. Attributes of the nodes may include one or more identifiers and/or any other characteristic(s) associated with the nodes. Interactions between the nodes of the social graph may include communications between nodes or other forms of interaction(s). For purposes of illustration and not of limitation, in a social media context, interactions between nodes may include messages, posts, tags, and/or the like.

At block 506, the first node (e.g., node 102) may receive, from a second node (e.g., a node 106), a request to establish a trust relationship. The second node may be associated with a social graph (e.g., social graph 303) in a manner similar to the first node. The social graph of the second node may include nodes that have one or more similar characteristics. The second node may also have a signature determined from its social graph in a manner similar to the signature associated with the first node. The second node's signature may be included in the request. A requested action may also be included in the request. For example, the second node may desire to join a group of which the first node is a part or access a resource to which the second node controls access. In this regard, the second node may send a request, including the requested action and the second node's signature, to the first node.

The social graph of the second node may be based on similar characteristics as the characteristics associated with the social graph of the first node. For example, the social graphs (e.g., social graphs 302, 303) may refer to connections in the same social network group. The social graph of the second node may overlap with the social graph of the first node such that the first and second nodes may have similar connections. The trust relationship may be based on the degree to which the social graphs of the first and second node overlap. The trust relationship may determine/establish, at least in part, the degree of trustworthiness between the first node and second node for activity authorization/authentication. As such, trust may be based, at least in part, on the relationships between nodes rather than manually assigned roles or permission levels. In this regard, examples of the present disclosure provide technical advancements/improvements in the areas of node authentication/trustworthiness and network platform security.

At block 508, the first node (e.g., node 102) may access a signature (e.g., a second signature), of the second node, determined based on a social graph (e.g., social graph 303) in response to receiving the request. The second node's signature may be based on the second node's social graph in a manner similar to how the first node's signature is based on the first node's social graph. Accessing may include retrieving from memory, receiving from another party/device, downloading from local/remote storage, generating, or any other form of obtaining the second node's signature. For example, the first node may request and receive the second node's signature from network device 104 and/or a third party (e.g., another server), which may generate and/or store the signature. As another example, the request may include the second signature, and the second signature may be extracted from the request.

At block 510, the first node (e.g., node 102) may determine a similarity level between the first node's signature and the second node's signature. The first node may include a trust engine (e.g., trust engine 212). The trust engine may include one or more integrity signature generation modules 211, which may analyze the social graphs (e.g., social graph 302, social graph 304) of the first node (e.g., node 102) and second node (e.g., node 106) and may generate a token(s) (e.g., a hash(es)) based on the values (e.g., unique identifiers of the connections) associated with at least portion/subset of the social graphs. In some examples, the one or more integrity signature generation modules 211 may implement/employ LSH mechanisms to generate the token(s), which may ensure that nodes having similar first-order connections may have similar token values. Accordingly, determining the similarity level may be based on LSH, or other suitable mechanisms, by which the signatures may be hashed and grouped into buckets according to the similarity of the hashes, and similarity may be based on the contents of one or more buckets (e.g., number of hashes) and/or the associated hash value of the one or more buckets.

At block 512, the first node (e.g., node 102) may approve or deny the request based on the determined similarity level. The approval may be indicated by a message, from the first node, to the second node and/or a third party. The approval may be based on a predetermined similarity level threshold such that the request may be approved if the similarity level is greater than or equal to the predetermined similarity level threshold. For example, if the request is approved, the second node may have the authorization to perform actions associated with the authorization, which may include a requested action(s) indicated in the second node's request. For example, the second node may receive authorization to join a friend group, in which the first node may be a group member, on a social network, and the authorization to join the friend group may extend to other actions in the friend group such as sending messages. On the other hand, the denial may be based on the predetermined similarity level threshold such that the request may be denied in an instance in which the similarity level is below the predetermined similarity level threshold.

In one or more examples, the similarity level may be compared against multiple predetermined similarity level thresholds corresponding to multiple authorization tiers. The request may be approved for an authorization tier corresponding to a predetermined similarity level threshold, among the predetermined similarity level thresholds, that the similarity level is greater than or equal to. Accordingly, the second node (e.g., node 106) may have the authorization to perform actions associated with the authorization tier, which may include the requested action(s) from the second node's request. For example, the second node may receive authorization to join a friend group on a social network but may not receive the authorization to send messages in the friend group.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order or partitioned differently) without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged or that all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device (e.g., a node).

As used herein, the phrase “at least one of” preceding a series of items, with the term “and” or “or” to separate any of the items, modifies the list as a whole rather than each member of the list (i.e., each item). The phrase “at least one of” does not require the selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of each of A, B, and C.

The predicate words “configured to,” “operable to,” and “programmed to” do not imply any particular tangible or intangible modification of a subject but, rather, are intended to be used interchangeably. In one or more embodiments, a processor configured to monitor and control an operation, or a component may also mean the processor being programmed to monitor and control the operation or the processor being operable to monitor and control the operation. Likewise, a processor configured to execute code may be construed as a processor programmed to execute code or operable to execute code.

Phrases such as an aspect, the aspect, another aspect, some aspects, one or more aspects, an implementation, the implementation, another implementation, some embodiments, one or more embodiments, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations or one or more configurations. A disclosure relating to such phrase(s) may provide one or more examples. A phrase such as an aspect or some aspects may refer to one or more aspects and vice versa, which applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the phrase “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public, regardless of whether such disclosure is explicitly recited in the claims. No claim element is to be construed under the provisions of 35 U.S.C. § 112 (f), unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine (e.g., her) and vice versa. Headings and subheadings, if any, are used for convenience only and do not limit the subject disclosure.

What is claimed is:

1. A method comprising:
accessing a first social graph comprising at least a first node, wherein the first node is associated with a first set of edges and a first set of neighboring nodes associated with the first set of edges;
accessing a first signature based on the first social graph;
receiving, by the first node, a request from a second node to establish a trust relationship;
accessing a second signature determined based on a second social graph in response to receiving the request;
determining a similarity level between the first signature and the second signature; and
generating an indication of approval or denial of the request based on the similarity level.

2. The method of claim 1, wherein the request comprises the second signature.

3. The method of claim 1, wherein one or more nodes of the first set of neighboring nodes comprise a set of edges and a set of neighboring nodes.

4. The method of claim 1, further comprising:
storing, at a network device, the first signature to determine subsequent similarity levels.

5. The method of claim 1, wherein generating the indication of approval is in response to determining the similarity level is greater than or equal to a predetermined similarity level threshold.

6. The method of claim 5, further comprising:
accessing a requested action associated with the request; and
performing the requested action in response to the indication of approval of the request.

7. The method of claim 1, further comprising:
comparing the similarity level to a plurality of predetermined similarity levels to determine an authorization tier associated with the requested action, wherein the plurality of predetermined similarity level correspond to a plurality of authorization tiers.

8. The method of claim 7, further comprising:
accessing a requested action associated with the request;
determining the authorization tier is associated with authorization of the requested action; and
authorizing performance of the requested action in response to determining the similarity level is greater than or equal to at least one of the plurality of predetermined similarity levels is associated with the authorization tier that is associated with the requested action.

9. The method of claim 1, further comprising:
determining the first signature based on a set of social graph attributes associated with the first social graph.

10. The method of claim 9, wherein the set of social graph attributes comprises at least one of attributes of the first set of edges, attributes of the first set of neighboring nodes, or interactions between the first set of neighboring nodes.

11. The method of claim 1, wherein determining the similarity level between the first signature and the second signature is based on locality sensitive hashing.

12. A system comprising:
a first node comprising one or more processors; and
at least one memory storing instructions, that when executed by the one or more processors, cause the first node to:
access a first social graph comprising at least the first node, wherein the first node is associated with a first set of edges and a first set of neighboring nodes associated with the first set of edges;
access a first signature based on the first social graph;
receive, by the first node, a request from a second node to establish a trust relationship;
access a second signature determined based on a second social graph in response to receiving the request;
determine a similarity level between the first signature and the second signature; and
generate an indication of approval or denial of the request based on the similarity level.

13. The system of claim 12, wherein when the one or more processors further execute the instructions, the first node is configured to:
generate the indication of approval is response to determining the similarity level is greater than or equal to a predetermined similarity level threshold.

14. The system of claim 13, wherein when the one or more processors further execute the instructions, the first node is configured to:
access a requested action associated with the request; and
perform the requested action in response to the indication of approval of the request.

15. The system of claim 12, wherein when the one or more processors further execute the instructions, the first node is configured to:
determine the first signature based on a set of social graph attributes associated with the first social graph.

16. The system of claim 15, wherein the set of social graph attributes comprises at least one of attributes of the first set of edges, attributes of the first set of neighboring nodes, or interactions between the first set of neighboring nodes.

17. The system of claim 12, wherein when the one or more processors further execute the instructions, the first node is configured to:
perform the determining the similarity level between the first signature and the second signature based on locality sensitive hashing.

18. A non-transitory computer-readable medium storing instructions that, when executed cause:
accessing a first social graph comprising at least a first node, wherein the first node is associated with a first set of edges and a first set of neighboring nodes associated with the first set of edges;
accessing a first signature based on the first social graph;
receiving, by the first node, a request from a second node to establish a trust relationship;
accessing a second signature determined based on a second social graph in response to receiving the request;
determining a similarity level between the first signature and the second signature; and
generating an indication of approval or denial of the request based on the similarity level.

19. The computer-readable medium of claim 18, wherein the generating the indication of approval is in response to determining the similarity level is greater than or equal to a predetermined similarity level threshold.

20. The computer-readable medium of claim 19, wherein the instructions, when executed, further cause:
accessing a requested action associated with the request; and
performing the requested action in response to the indication of approval of the request.
